(19) United States
(12) Patent Application Publication
(10) Pub. No.: US 2010/0002009 A1
(43) Pub. Date: Jan. 7, 2010

(54) DISPLAY DEVICE, A RECEIVING DEVICE AND A METHOD FOR DRIVING THE DISPLAY DEVICE

(76) Inventor: Yoshiki Takata, Mie (JP)

Correspondence Address: HARNESS, DICKEY & PIERCE, P.L.C., P.O. BOX 8910, RESTON, VA, 20195, US

(21) Appl. No.: 12/086,887

(22) PCT Filed: Jul. 7, 2006
(86) PCT No.: PCT/JP2006/313536

§ 371 Date: May 7, 2009

(51) Int. Cl. G09G 3/36; G09G 5/10; G09G 5/02

(52) U.S. Cl. 345/589; 345/102; 345/691

(57) ABSTRACT

One embodiment of the device includes a display panel and a light source evenly placed behind the panel, wherein the light source includes light source blocks divided and arranged in a matrix, includes an image judging unit which divides one frame of a video input signal into frame blocks each corresponding to a size of each of the light source blocks and judging whether images of the frame blocks are moving or still, and a light source block driving unit which blinks the light source block corresponding to the frame block the image of which is judged as moving by the judging unit upon receiving optical responses from the cells while turning on all the time the light source block corresponding to the frame block the image of which is judged as still by the judging unit.

### BACKGROUND OF THE INVENTION

1. Field of the Invention

The present invention relates to a display device which is excellent in image display quality.

2. Description of the Related Art

In recent years, a liquid crystal display device is widely used as a display unit of a home electric appliance such as a computer and a television. However, it is pointed out that the liquid crystal display device has a disadvantage that when an image including a moving image portion is displayed, an edge of the moving image portion is seen blurred, which is so-called “blurring of a moving image” in contrast to a cathode ray tube (CRT) display device which is conventionally used mainly for such a purpose. In the conventional CRT display device which performs display by scanning an electron beam and makes a fluorescent material emit light, an impulse-type display method is adopted in which emission of light from pixels is generally pulsed though persistence of the fluorescent material is slightly seen.

Meanwhile, in the liquid crystal display device, a hold-type display method is adopted in which charge stored by applying an electric field to liquid crystal is held in a comparatively high proportion until next application of the electric field is made, so that liquid crystal pixels continue to emit light until image information on a frame is rewritten by next application of the electric field based on image information on a next frame. Accordingly, in the liquid crystal display device, not only a present frame but also a previous frame is unintentionally visually perceived, which leads to reduction in display quality caused by the blurring of a moving image and other factors.

In order to solve the above-described problem, a method is developed by which image degradation such as blurring of a moving image which occurs in displaying a moving image is prevented by adopting a full flash-type turn-on system in which backlights are kept turned off until a given period of time passes after a signal of an image to be displayed is written and then the backlights are fully turned on.

In addition, in contrast to the full flash-type backlight turn-on system, a scanning-type backlight turn-on system is developed by which image degradation such as blurring of a moving image in displaying a moving image is prevented by scanning and turning on direct backlights one by one which are divided into light-emitting regions corresponding to divided display regions. FIG. 9 is a view showing a schematic configuration of a display device which is arranged so that display made by driving the device in the hold-type display method is made similar to display made by driving the CRT display device in the impulse-type display method.

As shown in FIG. 9, behind a liquid crystal display panel 40, a plurality of (eight in this example) direct fluorescent lamps 41a to 41h are placed in a direction parallel to a scanning line, and the fluorescent lamps 41a to 41h are turned on one by one in a top-to-bottom direction in synchronization with scanning signals of the liquid crystal display panel 40. The fluorescent lamps 41a to 41h correspond to display regions which are made by driving the liquid crystal display panel into eight regions in a vertical direction.

FIG. 10 is a time chart illustrating turn-on time of the fluorescent lamps shown in FIG. 9. In FIG. 10, the horizontal lines are for indicating whether the lamps 41a to 41h are turned on or not, and a length of time for one frame is divided into periods (1) to (8). For example, as for the fourth of the divided display regions from the top of the liquid crystal display panel 40, the fluorescent tube 41d which corresponds to the fourth divided display region is turned on during the period (3) after a lapse of the period (1) during which image information is written and the period (2) which is a response time from liquid crystal cells. In this manner, the operation to turn on only one of the lamps after the writing of the image information is repeated for each of the divided display regions during the length of time for one frame.

Accordingly, the display made by driving the device in the hold-type display method can be made similar to the display made by driving the CRT display device in the impulse-type display method, whereby an image of a previous frame is not visually perceived when displaying a moving image and reduction in display quality of the moving image due to blurring of the moving image can be prevented. Since in the scanning-type backlight turn-on system, each of the light-emitting regions corresponding to each of the divided display regions is turned on timely when optical responses from liquid crystal cells are sufficiently received, the periods of time from the writing of the image signals into the liquid crystal display panel 40 to the turn-on of the backlights can be made uniform irrespective of their positions (in a vertical direction) in a display screen. Therefore, the scanning-type backlight turn-on system has an advantage that the blurring of the moving image can be prevented sufficiently irrespective of the positions in the display screen. As a prior art literature relating to the present invention which is to be described below, Japanese Patent Application Unexamined Publication No. 2005-99367 is cited.

The above-described prior art aims to make the display made by driving the display device in the hold-type display method similar to the display made by driving the CRT display device in the impulse-type display method by turning on the backlights in the full-flash-type turn-on system or in the scanning-type turn-on system during the time for one frame (16.7 msec in the case of a typical progressive scan of 60 Hz) and shortening therefore the length of time for image display in order to prevent the image degradation due to the blurring of the moving image in displaying the moving image in a hold-type display device.

However, there is a problem that if the backlights blink in this manner, flicker in the display is visually perceived by a viewer and may cause eyestrain. Hence, the present inventor finds as a result of various studies that such flicker is reduced if the backlights are arranged to blink for a portion of the screen, not for the whole screen.

### SUMMARY OF THE INVENTION

In order to overcome the problems described above, preferred embodiments of the present invention provides a display device comprising a display panel comprising display cells placed in the vicinity of intersections between a plurality of scanning lines and a plurality of signal lines which intersect with each other at a right angle, and a light source evenly placed behind the display panel, the light source comprising a plurality of light source blocks divided and arranged in a matrix, and the display device further comprising an image judging unit arranged to divide one frame of a video input signal into a plurality of frame blocks each corresponding to a size of each of the light source blocks and judge whether respective images of the frame blocks are a moving image or a still image, and a light source block driving unit arranged to blink the light source block corresponding to the frame block the image of which has been judged as a moving image by the image judging unit upon receipt of optical responses from the display cells while arranged to turn on all the time the light source block corresponding to the frame block the image of which has been judged as a still image by the image judging unit.

In this case, it is preferable that the light source block driving unit is arranged to turn off the light source block corresponding to the frame block the image of which has been judged as a moving image until the optical responses from the display cells are sufficiently received, and turn on the light source block when the optical responses from the display cells are sufficiently received.

In addition, it is preferable that the light source block in its blinking operation is arranged so that a turn-on time period of the light source block is shorter as the moving image moves faster. Further it is preferable that the light source block during the turn-on time period in its blinking operation is arranged so that a light amount of the light source block increases as the turn-on time period in its blinking operation is shorter.

To achieve the objects and in accordance with the purpose of the present invention, a receiving device includes the display device.

In another aspect of the present invention also provides a method for driving a display device comprising a display panel comprising display cells placed in the vicinity of intersections between a plurality of scanning lines and a plurality of signal lines which intersect with each other at a right angle, and a light source evenly placed behind the display panel, the method comprising the steps of an image judging step of dividing one frame of a video input signal into a plurality of frame blocks each corresponding to a size of each of the light source blocks and judging whether respective images for the frame blocks are a moving image or a still image, and a light source block driving step of blinking the light source block corresponding to the frame block the image of which has been judged as a moving image by the image judging unit upon receipt of optical responses from the display cells while arranged to turn on all the time the light source block corresponding to the frame block the image of which has been is judged as a still image by the image judging unit.

In this case, it is preferable that the light source block driving unit is arranged to turn off the light source block corresponding to the frame block the image of which has been judged as a moving image until the optical responses from the display cells are sufficiently received, and turn on the light source block when the optical responses from the display cells are sufficiently received.

In addition, it is preferable that the light source block in its blinking operation is arranged so that a turn-on time period of the light source block is shorter as the moving image moves faster. Further, it is preferable that the light source block during the turn-on time period in its blinking operation is arranged so that a light amount of the light source block increases as the turn-on time period in its blinking operation is shorter.

According to the display device having the above-described configuration according to the preferred embodiment of the present invention and the method for driving the display device, the light source including the plurality of light source blocks divided and arranged in a matrix is evenly placed behind the display panel, one frame of the video input signal is divided into the plurality of frame blocks each corresponding to the size of each of the light source blocks, the light source block corresponding to the frame block the image of which has been judged as a moving image is arranged to blink upon receipt of the optical responses from the display cells, and the light source block corresponding to the frame block the image of which has been judged as a still image are arranged to be kept turned on, whereby the backlights are arranged to blink only for a portion of the moving image on the screen. That is to say, since the backlights are arranged to blink only a portion of the screen, not for the whole screen, blurring of the moving image is prevented and flicker is reduced compared with a full flash-type backlight turn-on system or a full sequential scanning-type backlight turn-on system which are used in the prior arts.

In this case, when the light source block driving unit is arranged to turn off the light source block until the optical responses from the display cells are sufficiently received, and turn on the light source block when the optical responses from the display cells are sufficiently received, image degradation is prevented in blinking the light source block corresponding to the frame block of which the image has been judged as a moving image for example in the flash-type turn-on system and the sequential scanning-type turn-on system since the light source block is not turned on while the optical responses from the display cells are not sufficiently received.

In addition, when the light source block in its blinking operation is arranged so that a turn-on time period of the light source block is shorter as the moving image moves faster, visibility of the moving image in a case where the moving image moves faster is improved and flicker in a case where the moving image moves slower is prevented. Further, when the light source block during the turn-on time period in its blinking operation is arranged so that a light amount of the light source block increases as the turn-on time period in its blinking operation is shorter, an integration value of the light amount of the light source block in its blinking operation, that is, brightness which is perceived by a viewer, can be made uniform, whereby a screen is prevented from being dark when displaying a moving image.

When a receiving device such as a television includes the display device having such a configuration, there is no blurring of a moving image and flicker caused by the blinking backlights is not visually perceived by a viewer even when a moving image with a faster movement such as a moving image displayed at the time of sports broadcasting is displayed, whereby no eyestrain is caused.

### BRIEF DESCRIPTION OF THE DRAWINGS

FIG. 1 is a view showing a schematic configuration of a display device according to a preferred embodiment of the present invention.

FIG. 2A is a view schematically showing one frame of a video input signal which is divided into a plurality of frame blocks, and FIG. 2B is a view schematically showing a light source defining backlights which is divided into a plurality of light source blocks in the display device according to the preferred embodiment of the present invention.

FIGS. 3A to 3C are views schematically showing specific examples of the light source in the display device according to the preferred embodiment of the present invention.

FIG. 4 is a view showing three frame images which are sequentially written in a display panel according to the preferred embodiment of the present invention.

FIGS. 5A to 5F are views showing states of turn-on and turn-off of the light source blocks and display states of the display panel at the time of sequentially writing the frame images as shown in FIG. 4.

FIGS. 6A to 6D are views showing a modified example of the states of the turn-on and turn-off of the light source blocks and the display states of the display panel during a period between those shown in FIG. 5A and those shown in FIG. 5B.

FIG. 7A is a graph showing a relationship in controlling the ratio of a turn-on time period to a turn-off time period of the light source blocks during a period of their blinking in accordance with the velocity of movement of a moving image, and FIG. 7B is a graph showing a relationship in adjusting light amounts of the light source blocks in accordance with the ratio of the turn-on time period to the turn-off time period of the light source blocks during the period of their blinking.

FIG. 8 is an exploded perspective view schematically showing components of a television receiving device including the display device according to the preferred embodiment of the present invention.

FIG. 9 is a view showing a state of blinking direct fluorescent lamps in a conventional liquid crystal display device.

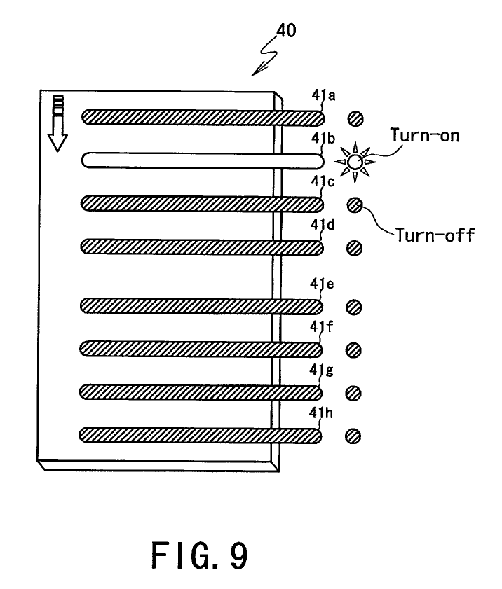

FIG. 10 is a time chart illustrating turn-on time of the lamps shown in FIG. 9.

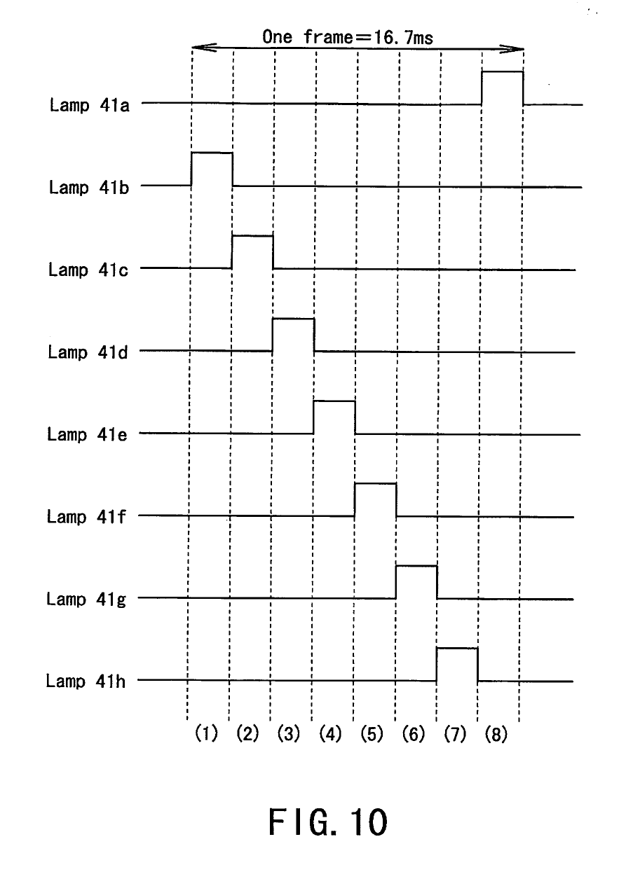

### DETAILED DESCRIPTION OF PREFERRED EMBODIMENTS

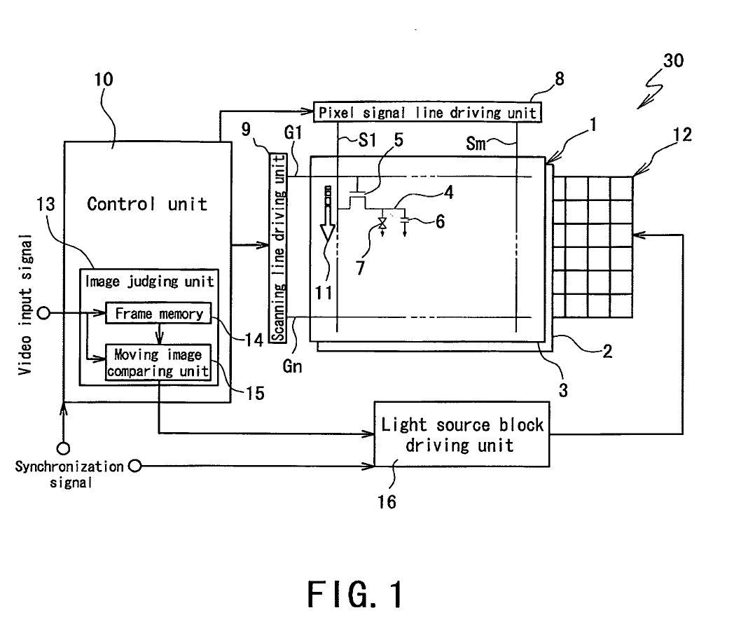

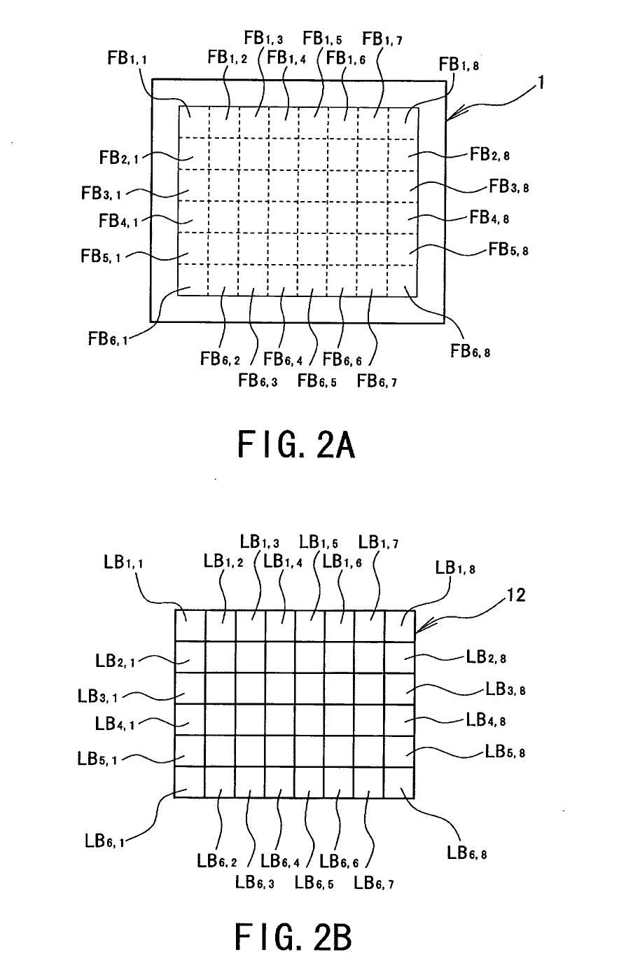

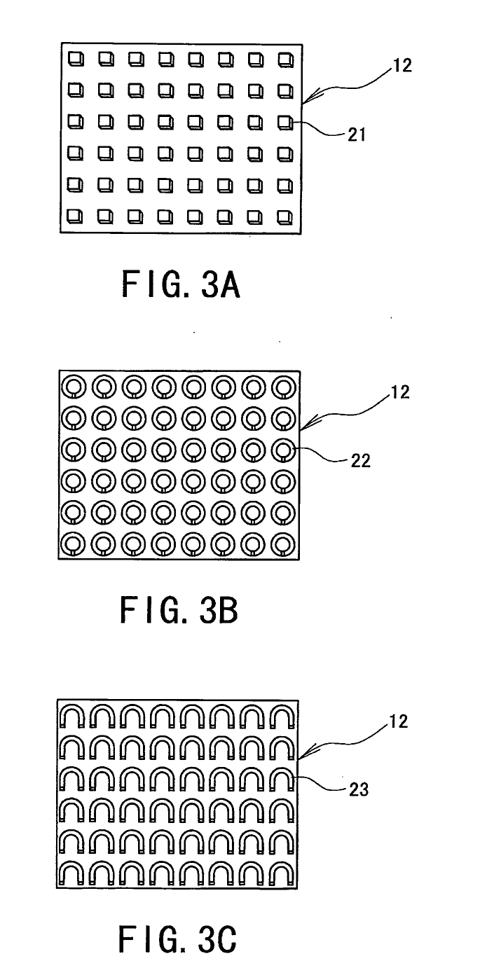

A detailed description of a display device according to a preferred embodiment of the present invention will now be provided with reference to the accompanying drawings. FIG. 1 is a view showing a schematic configuration of the display device, FIG. 2A is a view schematically showing one frame of an video input signal which is divided into a plurality of frame blocks, FIG. 2B is a view schematically showing a light source defining backlights which is divided into a plurality of light source blocks in the display device, and FIGS. 3A to 3C are views schematically showing specific examples of the light source in the display device.

A display device 30 includes a liquid crystal display panel 1 and a light source 12 including a plurality of light source blocks.

The liquid crystal display panel 1 includes an allay substrate 2 and a common substrate 3 made of a glass substrate which are placed to be opposed to each other at a given interval via liquid crystal, and the common substrate 3 is provided with a common electrode (not shown) on the almost entire surface.

The array substrate 2 is provided with pixel signal lines S1 to Sm which are placed in parallel extending in a vertical direction and scanning lines G1 to Gn which are placed in parallel extending in a horizontal direction such that the pixel signal lines and the scanning lines intersect with each other. Both of the lines form pixel regions arranged in a matrix, and a pixel electrode 4 is provided in each of the pixel regions. A thin film transistor 5 defining a switching element is provided in the vicinity of each of intersections of the both lines.

A source electrode of each of the thin film transistors 5 is connected with each of the pixel signal lines S1 to Sm, and a gate electrode of each of the thin film transistors 5 is connected with each of the scanning lines G1 to Gn. A drain electrode of each of the thin film transistors 5 is connected with each of the pixel electrodes 4 which are facing auxiliary capacitances 6 and liquid crystal 7.

The pixel signal lines S1 to Sm are connected to a pixel signal line driving unit 8, and the scanning lines G1 to Gn are connected to a scanning line driving unit 9. The pixel signal line driving unit 8 and the scanning line driving unit 9 are connected to a control unit 10 and are controlled by the control unit 10. An arrow 11 indicates a scanning direction in writing an image signal.

The control unit 10 includes an image judging unit 13. The image judging unit 13 is provided with a frame memory 14 and a moving image comparing unit 15. A memory device such as a random-access memory (RAM) is used as the frame memory 14 and the frame memory 14 stores a video input signal for a frame. The moving image comparing unit 15 divides one frame of the video input signal into forty-eight frame blocks FB_{1,1} to FB_{6,8} in six rows and eight columns as shown in FIG. 2A, judges whether respective images of the frame blocks FB_{1,1} to FB_{6,8}, are a moving image or a still image, and outputs their results to a light source block driving unit 16. In the preferred embodiment of the present invention, the moving image comparing unit 15 detects based on the video input signals motion vectors in the frame blocks FB_{1,1} to FB_{6,8} between present frame images and previous frame images stored in the frame memory 14 in temporally continuous image, and judges based on the detected motion vectors whether the present frame images of each of the frame blocks FB_{1,1} to FB_{6,8} are a moving image or a still image.

Behind the liquid crystal display panel 1 having a configuration as described above, the light source 12 is provided. The light source 12 includes a plurality of the light source blocks which are divided and arranged in a matrix. In the preferred embodiment of the present invention, the light source 12 includes forty-eight light source blocks LB_{1,1} to LB_{6,8} in six rows and eight columns as shown in FIG. 2B, and the size of each of the light source blocks LB_{1,1} to LB_{6,8} from which light is irradiated to the liquid crystal display panel 1 is almost the same as that of each of the frame blocks FB_{1,1} to FB_{6,8}.

The light source blocks LB_{1,1} to LB_{6,8} are arranged to be able to be driven independently by the light source block driving unit 16, and therefore, the light source block driving unit 16 controls each of the light source blocks LB_{1,1} to LB_{6,8} to turn on and turn off based on output signals of the judgment results outputted from the image judging unit 13. For the light source 12 which is divided into a plurality of the light source blocks, LED elements 21 shown in FIG. 3A are preferably used. Alternatively, circular fluorescent lamps 22 shown in FIG. 3B or U-shaped fluorescent lamps 23 shown in FIG. 3C are preferably used.

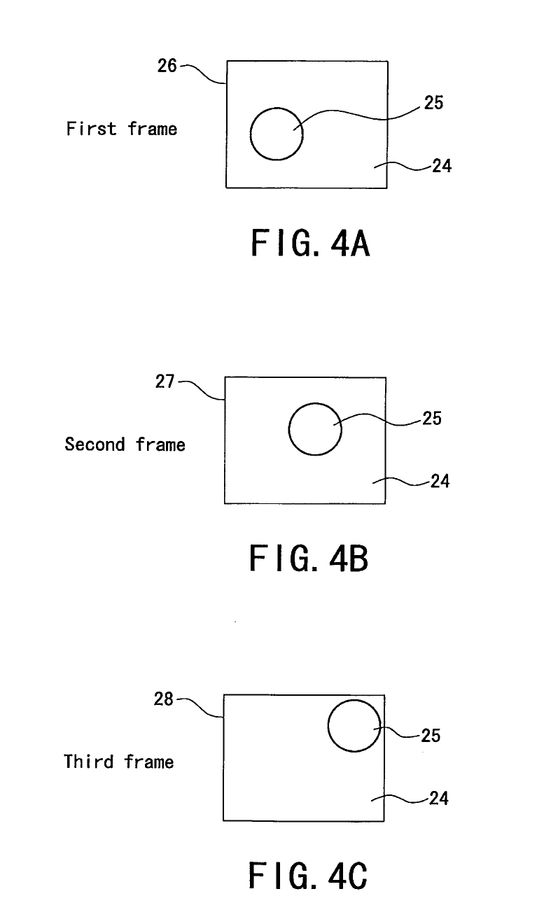

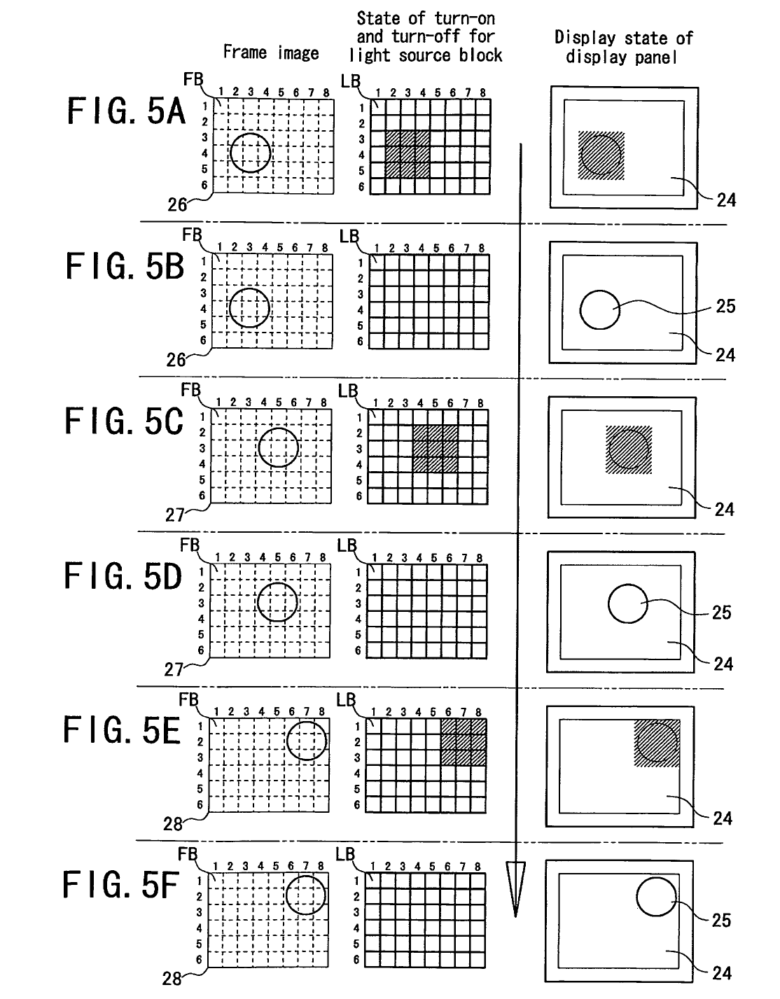

Next, the procedure of operation of the light source blocks LB_{1,1} to LB_{6,8} is described with reference to FIG. 4 and FIGS. 5A to 5F. FIG. 4 is a view showing three frame images 26, 27 and 28 which are sequentially written in the liquid crystal display panel 1 in the case of displaying an image that a circular object 25 displayed against a background 24 moves from the bottom left to the upper right. FIGS. 5A to 5F are views showing states of turn-on and turn-off for each of the light source blocks LB_{1,1} to LB_{6,8} and display states of the display panel 1 at the time of sequentially writing the three frame images 26, 27 and 28.

First, in FIG. 5A, the states before sufficiently receiving optical responses from liquid crystal display cells in the process of writing the image 26 or just after the completion of the writing is shown, where the light source blocks LB_{3,2} to LB_{3,4}, LB_{4,2} to LB_{4,4} and LB_{5,2} to LB_{5,4} immediately behind the frame blocks FB_{3,2} to FB_{3,4}, FB_{4,2} to FB_{4,4} and FB_{5,2} to FB_{5,4} where the object 25 which has been judged as a moving image by the image judging unit 13 is positioned are turned off. Accordingly, the display state of the display panel 1 is such that a portion of the frame blocks where the object 25 is positioned is displayed in black and only the background 24 is displayed as shown in FIG. 5A. Then, when the optical responses from the liquid crystal display cells are sufficiently received, the light source blocks LB_{3,2} to LB_{3,4}, LB_{4,2} to LB_{4,4} and LB_{5,2} to LB_{5,4} immediately behind the frame blocks FB_{3,2} to FB_{3,4}, FB_{4,2} to FB_{4,4} and FB_{5,2} to FB_{5,4}, which have been turned off, are turned on as shown in FIG. 5B. Therefore, the display state of the display panel 1 becomes such that the object 25 is displayed against the background 24 as shown in FIG. 5B.

Next, in FIG. 5C, the states before sufficiently receiving optical responses from liquid crystal display cells in the process of writing the image 27 or just after the completion of the writing is shown, where the light source blocks LB_{2,4} to LB_{2,6}, LB_{3,4} to LB_{3,6} and LB_{4,4} to LB_{4,6} immediately behind the frame blocks FB_{2,4} to FB_{2,6}, FB_{3,4} to FB_{3,6} and FB_{4,4} to FB_{4,6} where the object 25 which has been judged as a moving image by the image judging unit 13 is positioned are turned off. Accordingly, the display state of the display panel 1 is such that a portion of the frame blocks where the object 25 is positioned is displayed in black and only the background 24 is displayed as shown in FIG. 5C. Then, when the optical responses from the liquid crystal display cells are sufficiently received, the light source blocks LB_{2,4} to LB_{2,6}, LB_{3,4} to LB_{3,6} and LB_{4,4} to LB_{4,6} immediately behind the frame blocks FB_{2,4} to FB_{2,6}, FB_{3,4} to FB_{3,6} and FB_{4,4} to FB_{4,6} which have been turned off, are turned on as shown in FIG. 5D. Therefore, the display state of the display panel 1 becomes such that the object 25 is displayed against the background 24 as shown in FIG. 5D.

Next, in FIG. 5E, the states before sufficiently receiving optical responses from liquid crystal display cells in the process of writing the image 28 or just after the completion of the writing is shown, where the light source blocks LB_{1,6} to LB_{1,8}, LB_{2,6} to LB_{2,8} and LB_{3,6} to LB_{3,8} immediately behind the frame blocks FB_{1,6} to FB_{1,8}, FB_{2,6} to FB_{2,8} and FB_{3,6} to FB_{3,8} where the object 25 which has been judged as a moving image by the image judging unit 13 is positioned are turned off. Accordingly, the display state of the display panel 1 is such that a portion of the frame blocks where the object 25 is positioned is displayed in black and only the background 24 is displayed as shown in FIG. 5E. Then, when the optical responses from the liquid crystal display cells are sufficiently received, the light source blocks LB_{1,6} to LB_{1,8}, LB_{2,6} to LB_{2,8} and LB_{3,6} to LB_{3,8} immediately behind the frame blocks FB_{1,6} to FB_{1,8}, FB_{2,6} to FB_{2,8} and FB_{3,6} to FB_{3,8}, which have been turned off, are turned on as shown in FIG. 5F. Therefore, the display state of the display panel 1 becomes such that the object 25 is displayed against the background 24 as shown in FIG. 5F.

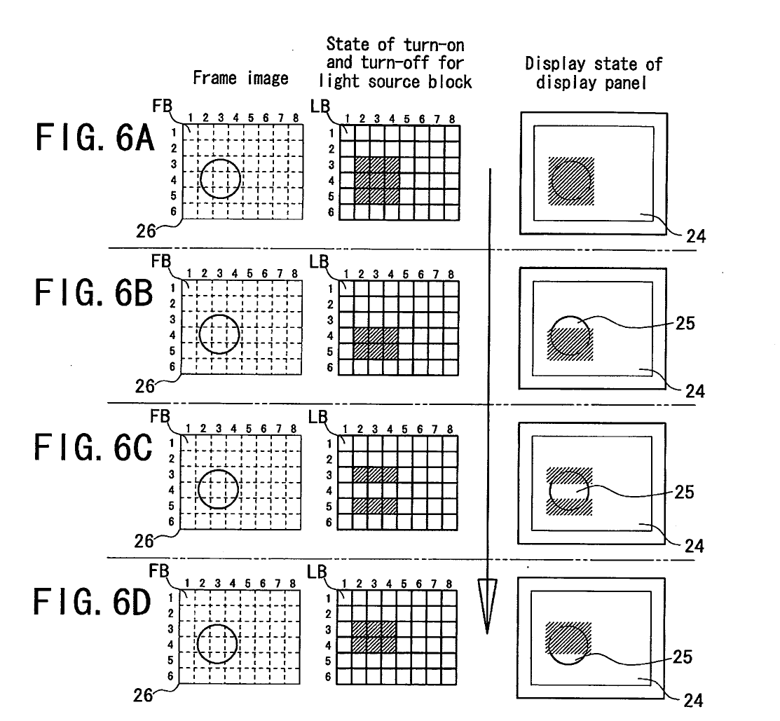

Three-by-three light source blocks immediately behind the frame blocks where the object 25 is positioned as shown in FIGS. 5A to 5F are turned on or turned off by a flash-type turn-on system by which the turn-on and turn-off are performed in all at once. Alternatively, a sequential scanning-type turn-on system by which the turn-on and turn-off of the light source blocks are performed three by three in the same direction as the scanning direction in writing the image signal as shown in FIGS. 6A to 6D is preferably used.

In FIG. 6A, the states before sufficiently receiving optical responses from liquid crystal display cells in the process of writing the image 26 or just after the completion of the writing is shown, where the light source blocks LB_{3,2} to LB_{3,4}, LB_{4,2} to LB_{4,4} and LB_{5,2} to LB_{5,4} immediately behind the frame blocks FB_{3,2} to FB_{3,4}, FB_{4,2} to FB_{4,4} and FB_{5,2} to FB_{5,4} where the object 25 which has been judged as a moving image by the image judging unit 13 is positioned are turned off. Accordingly, the display state of the display panel 1 is such that a portion of the frame blocks where the object 25 is positioned is displayed in black and only the background 24 is displayed as shown in FIG. 6A.

When the optical responses from the liquid crystal display cells are sufficiently received, the light source blocks LB_{3,2} to LB_{3,4} immediately behind the frame blocks FB_{3,2} to FB_{3,4}, which have been turned off, are turned on firstly as shown in FIG. 6B, and the display state of the display panel 1 becomes such that an upper portion of the object 25 is displayed against the background 24 as shown in FIG. 6B. Next, when the light source blocks LB_{3,2} to LB_{3,4} immediately behind the frame blocks FB_{3,2} to FB_{3,4}, which have been turned on, are turned off and the light source blocks LB_{4,2} to LB_{4,4} immediately behind the frame blocks FB_{4,2} to FB_{4,4}, which have been turned off, are turned on as shown in FIG. 6C, the display state of the display panel 1 becomes such that a central portion of the object 25 is displayed against the background 24 as shown in FIG. 6C.

Finally, when the light source blocks LB_{4,2} to LB_{4,4} immediately behind the frame blocks FB_{4,2} to FB_{4,4}, which have been turned on, are turned off and the light source blocks LB_{5,2} to LB_{5,4} immediately behind the frame blocks FB_{5,2} to FB_{5,4}, which have been turned off, are turned on as shown in FIG. 6D, the display state of the display panel 1 becomes such that a lower portion of the object 25 is displayed against the background 24 as shown in FIG. 6D.

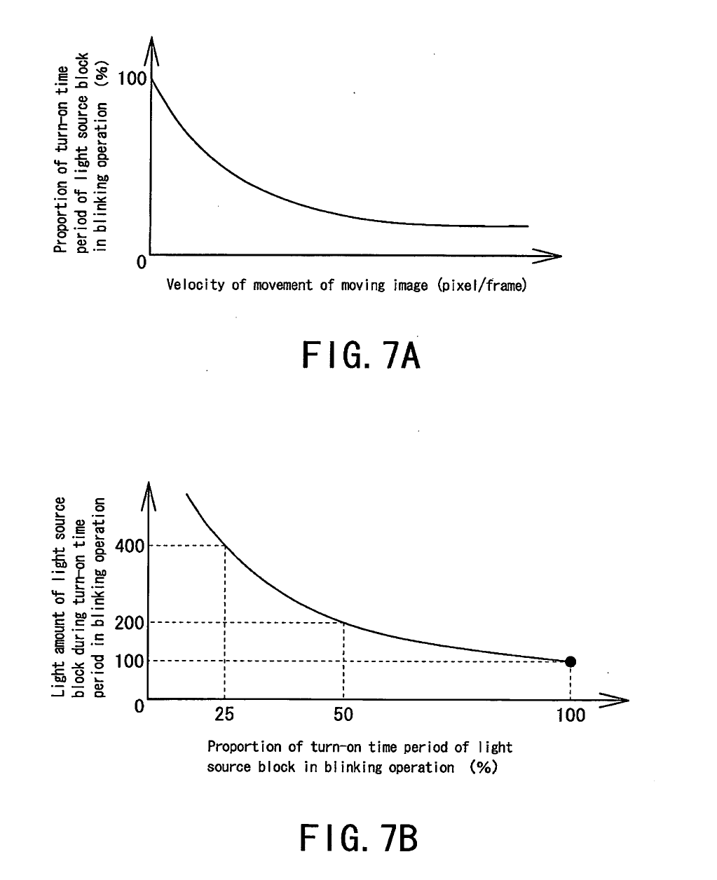

FIG. 7A is a graph showing a relationship in controlling the ratio of a turn-on time period to a turn-off time period of the light source blocks during a period of their blinking in accordance with the velocity of movement of a moving image. The influence of blurring of a moving image in a hold-type display method becomes greater as the moving image moves faster. Therefore, in order to prevent such a problem, it is preferably arranged that the image judging unit 13 judges the velocity of the movement of the moving image, and control of shortening the turn-on time period and prolonging the turn-off time period of the light source blocks in their blinking operation with the velocity is performed as shown in FIG. 7A. Conversely, when the moving image moves slower, control of prolonging the turn-on time period and shortening the turn-off time period of the light source blocks is performed, whereby there is no flicker even if the viewer gazes at a screen and preferable visibility of the moving image is achieved.

FIG. 7B is a graph showing a relationship in adjusting light amounts of the light source blocks in accordance with the ratio of the turn-on time period to the turn-off time period of the light source blocks during the period of their blinking. When the light source blocks blink in accordance with the movement of the moving image, integration values of the light amounts during the turn-on time period become an actual value of brightness perceived by the viewer. Hence, it is preferably arranged that control of increasing the light amounts of the light source blocks during the turn-on time period with the prolonged turn-off time period in their blinking operation is performed.

For example, as shown in FIG. 7B, the light smounts of the light source blocks are 100 when the proportion of the turn-on time period of the light source blocks in their blinking operation is 100%, that is, the light amounts of the light source blocks in their continuously lighting operation. Accordingly, if the proportion is 50%, that is, if the turn-on time period and the turn-off time period in the blinking operation are equal, the light amounts are multiplied by two and increased to 200. If the proportion is 25%, the light amounts are multiplied by four and increased to 400. Accordingly, the brightness perceived by the viewer can be made uniform, whereby the screen is prevented from getting dark in displaying a moving image.

According to the display device having the above-described configuration according to the preferred embodiment of the present invention and the method for driving the display device, the light source including the plurality of light source blocks divided in a matrix is evenly placed behind the display panel, one frame of the video input signal is divided into the plurality of frame blocks each immediately behind the size of each of the light source blocks, the light source block immediately behind the frame block the image of which has been judged as a moving image is arranged to blink upon receipt of the optical responses from the display cells, and the light source block immediately behind the frame block the image of which has been is judged as a still image are arranged to be kept turned on, whereby the backlights are arranged to blink on only for a portion of the moving image on the screen. That is to say, since the backlights are arranged to blink only a portion of the screen, not for the whole screen, blurring of the moving image is prevented and flicker is reduced compared with a full flash-type backlight turn-on system or a sequential scanning-type backlight turn-on system by which the blinking operation is performed for the whole screen, which are used in the prior arts.

In this case, when the light source block driving unit is arranged to turn off the light source block until the optical responses from the display cells are sufficiently received, and turn on the light source block when the optical responses from the display cells are sufficiently received, image degradation is prevented in blinking the light source block immediately behind the frame block of which the image has been judged as a moving image for example in the flash-type turn-on system and the sequential scanning-type turn-on system since the light source block is not turned on while the optical responses from the display cells are not sufficiently received.

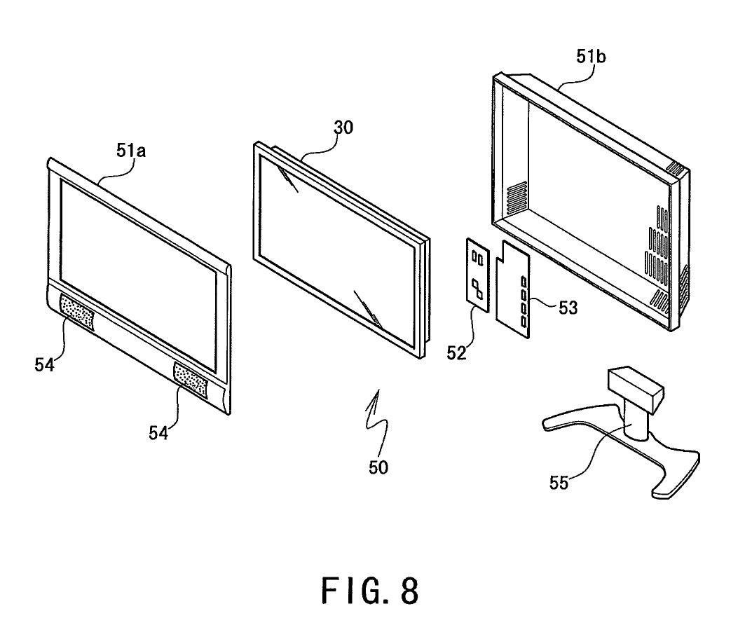

Next, a television receiving device including the above-described display device is briefly described. FIG. 8 is an exploded perspective view schematically showing one example of components of the television receiving device including the display device according to the above-described preferred embodiment of the present invention. A television receiving device 50 includes a tuner 52 arranged to generate a video signal and a sound signal of a designated channel from received radio waves and an input signal inputted from the outside, a display device 30 arranged to display an image based on the video signal generated by the tuner 52, a loudspeaker mechanism 54 arranged to emit a sound based on the sound signal generated by the tuner 52, and a power source substrate 53 arranged to supply power to the tuner 52, the display device 30 and the loudspeaker mechanism 54.

A conventional terrestrial tuner (analog, a digital, or both), a BS tuner, and a CS tuner can be preferably used as the tuner 52, and a conventional loudspeaker mechanism such as a common speaker can be used as the loudspeaker mechanism 54, so that detailed descriptions thereof are omitted. In addition, the display device according to the above-described preferred embodiments of the present invention is used as the display device 30.

As shown in FIG. 8, the display device 30, the tuner 52, the loudspeaker mechanism 54 and the power source substrate 53 are housed in a cabinet including a front-side cabinet 51a and a rear-side cabinet 51b, which is supported by a stand 55. By incorporating the display device 30 according to the above-described preferred embodiment of the present invention into the television receiving device 50 having such a configuration, it is possible to provide a television receiving device in which there is no blurring of a moving image and flicker caused by blinking the backlights is not visually perceived by a viewer even when a moving image with a faster movement such as a moving image displayed at the time of sports broadcasting, whereby no eyestrain is caused.

The foregoing description of preferred embodiments and the implementation example of the present invention has been presented for purposes of illustration and description with reference to the drawings. However, it is not intended to limit the present invention to the preferred embodiments, and modifications and variations are possible as long as they do not deviate from the principles of the present invention. For example, while the light source blocks in six rows and eight columns are used in the above-described preferred embodiment of the present invention, it is also preferable to decrease the size of each of the light source blocks and increase the number of divisions. In this case, the effect in the sequential scanning-type turn-on system described referring to FIG. 6A to 6D is enhanced. Alternatively, it is also preferable to increase the size of each of the light source blocks and decrease the number of the divisions. In this case, the number of processes of the judgment made by the image judging unit is reduced and a load imposed on the light source block driving unit in controlling the light source blocks is also reduced.

1. A display device comprising a display panel comprising display cells placed in the vicinity of intersections between a plurality of scanning lines and a plurality of signal lines which intersect with each other at a right angle, and a light source evenly placed behind the display panel,
wherein the light source comprises a plurality of light source blocks divided and arranged in a matrix, and
the display device further comprising:
an image judging unit arranged to divide one frame of a video input signal into a plurality of frame blocks each corresponding to a size of each of the light source blocks and judge whether respective images of the frame blocks are a moving image or a still image; and
a light source block driving unit arranged to blink the light source block corresponding to the frame block the image of which has been judged as a moving image by the image judging unit upon receipt of optical responses from the display cells while arranged to turn on all the time the light source block corresponding to the frame block the image of which has been judged as a still image by the image judging unit.

2. The display device according to claim 1, wherein the light source block driving unit is arranged to turn off the light source block corresponding to the frame block the image of which has been judged as a moving image until the optical responses from the display cells are sufficiently received, and turn on the light source block when the optical responses from the display cells are sufficiently received.

3. The display device according to claim 1, wherein the light source block in its blinking operation is arranged so that a turn-on time period of the light source block is shorter as the moving image moves faster.

4. The display device according to claim 1, wherein the light source block during the turn-on time period in its blinking operation is arranged so that a light amount of the light source block increases as the turn-on time period in its blinking operation is shorter.

5. A receiving device comprising the display device according to claim 1.

6. A method for driving a display device comprising a display panel comprising display cells placed in the vicinity of intersections between a plurality of scanning lines and a plurality of signal lines which intersect with each other at a right angle, and a light source evenly placed behind the display panel, the method comprising the steps of:
an image judging step of dividing one frame of a video input signal into a plurality of frame blocks each corresponding to a size of each of the light source blocks and judging whether respective images for the frame blocks are a moving image or a still image; and
a light source block driving step of blinking the light source block corresponding to the frame block the image of which has been judged as a moving image by the image judging unit upon receipt of optical responses from the display cells while arranged to turn on all the time the light source block corresponding to the frame block the image of which has been judged as a still image by the image judging unit.

7. The method for driving the display device according to claim 6, wherein the light source block driving unit is arranged to turn off the light source block corresponding to the frame block the image of which has been judged as a moving image until the optical responses from the display cells are sufficiently received, and turn on the light source block when the optical responses from the display cells are sufficiently received.

8. The method for driving the display device according to claim 6, wherein the light source block in its blinking operation is arranged so that a turn-on time period of the light source block is shorter as the moving image moves faster.

9. The method for driving the display device according to claim 6, wherein the light source block during the turn-on time period in its blinking operation is arranged so that a light amount of the light source block increases as the turn-on time period in its blinking operation is shorter.

10. The display device according to claim 2, wherein the light source block in its blinking operation is arranged so that a turn-on time period of the light source block is shorter as the moving image moves faster.

11. The display device according to claim 2, wherein the light source block during the turn-on time period in its blinking operation is arranged so that a light amount of the light source block increases as the turn-on time period in its blinking operation is shorter.

12. The display device according to claim 2, wherein the light source block during the turn-on time period in its blinking operation is arranged so that a light amount of the light source block increases as the turn-on time period in its blinking operation is shorter.

13. A receiving device comprising the display device according to claim 2.

14. A receiving device comprising the display device according to claim 3.

15. A receiving device comprising the display device according to claim 4.

16. The method for driving the display device according to claim 7, wherein the light source block in its blinking operation is arranged so that a turn-on time period of the light source block is shorter as the moving image moves faster.

17. The method for driving the display device according to claim 7, wherein the light source block during the turn-on time period in its blinking operation is arranged so that a light amount of the light source block increases as the turn-on time period in its blinking operation is shorter.

18. The method for driving the display device according to claim 8, wherein the light source block during the turn-on time period in its blinking operation is arranged so that a light amount of the light source block increases as the turn-on time period in its blinking operation is shorter.
